(19) United States
(12) Patent Application Publication
(10) Pub. No.: US 2025/0125615 A1
(43) Pub. Date: Apr. 17, 2025

(54) INVERTER-BASED RESOURCE (IBR) OPTIMIZED FAULT-LEVEL ADJUSTMENT BASED ON FAULT LOCATION

(71) Applicant: SIEMENS CORPORATION, Washington, DC (US)

(72) Inventors: Xiaofan Wu, North Brunswick, NJ (US); Ulrich Muenz, Princeton, NJ (US); Suat Gumussoy, Princeton, NJ (US); Reza Ganjavi, Uttenreuth (DE)

(73) Assignee: Siemens Corporation, Washington, DC (US)

(21) Appl. No.: 18/683,836

(22) PCT Filed: Aug. 22, 2022
(86) PCT No.: PCT/US2022/041030

§ 371 Date: Feb. 15, 2024

(51) Int. Cl. H02J 3/00; G05B 13/04

(52) U.S. Cl. CPC H02J 3/0012; G05B 13/041

(57) ABSTRACT

An optimized protection system for a power system consisting of power lines, transformers, generation units, and loads is provided. The optimized protection system includes grid-protection units (GPUs) each including at least one grid-protection unit protection function (GPU PF) that detects fault signals like currents or voltages and disconnects a power line, a transformer, a generation unit, or a load based on the GPU PF. The optimized protection system further includes a plurality of inverter-based resources (IBRs) as the generation units such that an IBR includes an inverter-based resource supervisory controller (IBR SC) that controls an inverter-based resource (IBR) output. The optimized protection system further includes a protection system co-optimizer for co-optimization of the IBR SC and the GPU PF such that they together optimize the protection system performance regarding dependability, security, and operation speed for any kind of grid faults.

### CROSS REFERENCE TO RELATED APPLICATIONS

This application claims the benefit of U.S. Provisional Application Ser. No. 63/236,766 entitled “PROTECTION SCHEMES FOR INVERTER-DOMINATED POWER SYSTEMS,” filed on Aug. 25, 2021, the contents of which are hereby incorporated by reference herein in their entirety.

### BACKGROUND

### 1. Field

Aspects of the present invention generally relate to a system and a method that enable an optimized protection system having an equipment-level protection scheme which contains first and second control units and a system-level optimizer that co-optimizes an inverter-based resource (IBR), the first control unit, the second control unit and grid protection units (GPUs) to provide an IBR optimized fault-level adjustment based on one or more fault locations. The protection system includes grid-protection units (GPUs) each including at least one grid-protection unit protection function (GPU PF) that detects fault signals like currents or voltages and disconnects a power line, a transformer, a generation unit, or a load based on the GPU PF.

### 2. Description of the Related Art

Inverter response to a fault is very different from synchronous generators (SGs). In addition, traditional one direction power flow from generation/substation to load centers disappears in inverter-based resource (IBR)-dominated grids and transform itself to multi-direction power flow among IBRs. Both facts challenge existing grid protection units (GPUs) using current, impedance, and direction measurements to operate correctly (i.e., dependable, secure, and fast) during a grid fault. For example, phase and ground elements in over-current, and distance protections.

Recently, increased numbers of grid-following (GFL) inverters have been integrated into power systems. They exhibit two main differences to SGs when it comes to protection analysis: (a) they cannot provide sustained fault currents significantly higher than their nominal current and (b) their fault response is highly dependent on their proprietary inverter Control and Protection (C&P) functions and not on the physics of the inverter. Today, there is not even an IBR fault response standardization through interconnection standards and/or a grid code in the US, although draft IEEE P2800 has certain specifications under consideration.

In grid-forming (GFM) inverters, the IBRs control the inverter's output voltage depending on the current infeed, e.g., using f (P) droops; in contrast, GFL IBRs control the inverter's output current depending on the current grid voltage.

In IBR-dominated grids, grid-forming (GFM) inverters are required to maintain power system stability. These GFM IBRs exhibit the same differences to SGs as GFL IBRs listed above: low fault currents and dynamic fault response depending on proprietary inverter software. Moreover, GFM IBRs control the output voltage during normal operation which makes the grid protection of the GFM IBR even more challenging compared to GFL IBRs.

Ongoing research propose building more communication layer:
a) Among grid protection device (device to device communication).
b) A centralized and decentralized intelligent center(s) to adapt grid protection settings via a communication infrastructure.

Therefore, there is a need of a better protection system.

### SUMMARY

Briefly described, aspects of the present invention relate to an optimized protection system having an equipment-level protection scheme which contains first and second control units and a system-level optimizer that co-optimizes an inverter-based resource (IBR), the first control unit, the second control unit and grid protection units (GPUs) to provide an IBR optimized fault-level adjustment based on one or more fault locations. Embodiments of present invention are based on the idea that a supervisory controller (IBR SC) and a Fault Type and Location Detector (FTLD) unit are integrated at each Inverter Based Resource (IBR) location. FTLD has also close-fault-zone characteristics to define which close faults should be considered for IBR output adjustment. For such close faults, each IBR produces adaptively enough reactive and/or active fault currents so that existing grid protection units (GPUs) detect and isolate the faulty part(s). Proposed invention defines the IBR output/contribution e.g., Voltage, Current, Frequency, and Power Factor (Cos Phi) during a fault incident by using one or more fault types and locations identified by the FTLD unit. IBR output/contribution are controlled in a closed loop feedback at two levels.

In accordance with one illustrative embodiment of the present invention, a protection system for a power system consisting of power lines, transformers, generation units, and loads is provided. The protection system comprises one or more grid-protection units (GPUs) associated with the power lines, the transformers, the generation units, or the loads of the power system. A grid-protection unit (GPU) includes at least one grid-protection unit protection function (GPU PF) that detects fault signals like currents or voltages and disconnects a power line, a transformer, a generation unit, or a load based on the GPU PF. The protection system further comprises a plurality of inverter-based resources (IBRs) as the generation units. An IBR includes an inverter-based resource supervisory controller (IBR SC) that controls an inverter-based resource (IBR) output. The protection system further comprises a processor and a memory for storing algorithms executed by the processor. The algorithms comprise a protection system co-optimizer for co-optimization of the IBR SC and the GPU PF such that they together optimize the protection system performance regarding dependability, security, and operation speed for any kind of grid faults.

In accordance with another illustrative embodiment of the present invention, a method of adaptively adjusting an inverter-based resource (IBR) optimized fault-level based on one or more fault locations in an optimized protection system. The method comprises providing an inverter-based resource supervisory controller (IBR SC) that controls an inverter-based resource (IBR) output. The method further comprises providing a fault type and location detector (FTLD) unit integrated with the IBR SC at each inverter-based resource (IBR) location of one or more IBR locations. The FTLD unit identifies one or more fault types and locations in a power grid. The FTLD unit has also close-fault-zone characteristics to define which close faults should be considered for an IBR output adjustment. For such close faults, each IBR produces adaptively enough reactive and/or active fault currents so that existing grid protection units (GPUs) detect and isolate the faulty part(s). The method further comprises providing a system co-optimizer for co-optimization of the IBR, the IBR SC, FTLD close fault zones and the GPU PF such that they together optimize the optimized protection system performance regarding dependability, security, and operation speed for any kind of grid faults.

In accordance with another illustrative embodiment of the present invention, a protection system for a power system consisting of power lines, transformers, generation units, and loads is provided. The system comprises one or more grid protection units (GPUs) that represent all other existing protection devices in a power grid. The system further comprises an equipment-level protection scheme which contains first and second control units. The first control unit controls an inverter-based resource (IBR) output and the second control unit identifies one or more fault types and locations in the power grid. The system further comprises a system-level optimizer for co-optimization of an IBR, the first control unit, the second control unit together with the one or more grid protection units (GPUs) such that they together optimize the global protection performance regarding dependability, security, and operation speed for any kind of grid faults. The equipment-level protection scheme and the system-level optimizer adaptively provides an IBR optimized fault-level adjustment based on the fault location of one or more fault locations.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 illustrates a block diagram of an optimized protection system in which an equipment-level protection scheme is integrated with a system-level optimizer to provide an IBR adaptive fault-level adjustment based on one or more fault locations in accordance with an exemplary embodiment of the present invention.

FIG. 2 illustrates a block diagram of an optimized protection system in which an inverter-based resource supervisory controller (IBR SC) is integrated with a fault type and location detector (FTLD) unit and a system co-optimizer to provide an IBR adaptive fault-level adjustment based on one or more fault locations in accordance with an exemplary embodiment of the present invention.

FIG. 3 illustrates a schematic view of a flow chart of a method of adaptively adjusting an inverter-based resource (IBR) optimized fault-level based on one or more fault locations in accordance with an exemplary embodiment of the present invention.

### DETAILED DESCRIPTION

Various technologies that pertain to systems and methods that facilitate an adjustment mechanism to adjust an inverter-based resource (IBR) optimized fault-level based on one or more fault locations will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to example non-limiting embodiments.

To facilitate an understanding of embodiments, principles, and features of the present invention, they are explained hereinafter with reference to implementation in illustrative embodiments. In particular, they are described in the context of an optimized protection system that comprises a supervisory controller (IBR SC) and a Fault Type and Location Detector (FTLD) unit that are integrated at each Inverter Based Resource (IBR) location as well as grid protection units (GPUs). FTLD has also close-fault-zone characteristics to define which close faults should be considered for IBR output adjustment. For such close faults, each IBR produces adaptively enough reactive and/or active fault currents so that existing grid protection units (GPUs) detect and isolate the faulty part(s). Automatic optimization of protection schemes (together with generator controller parameters) is proposed. A co-optimized protection settings can be implemented via such on-line adaptive systems. Present invention protects reliably IBR dominated power grids of any inverter type (GFL, or GFM) without a need to build any additional communication infrastructure. Only contribution of IBRs which are close to one or more fault locations are adjusted so that existing grid protection units (e.g., overcurrent or distance) enable to detect and isolate a grid fault reliably (i.e., dependable, secure and with fast speed). Other IBR contribution to that grid fault will not be increased unnecessarily. This avoids that power system short-circuit level becomes unnecessarily high. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

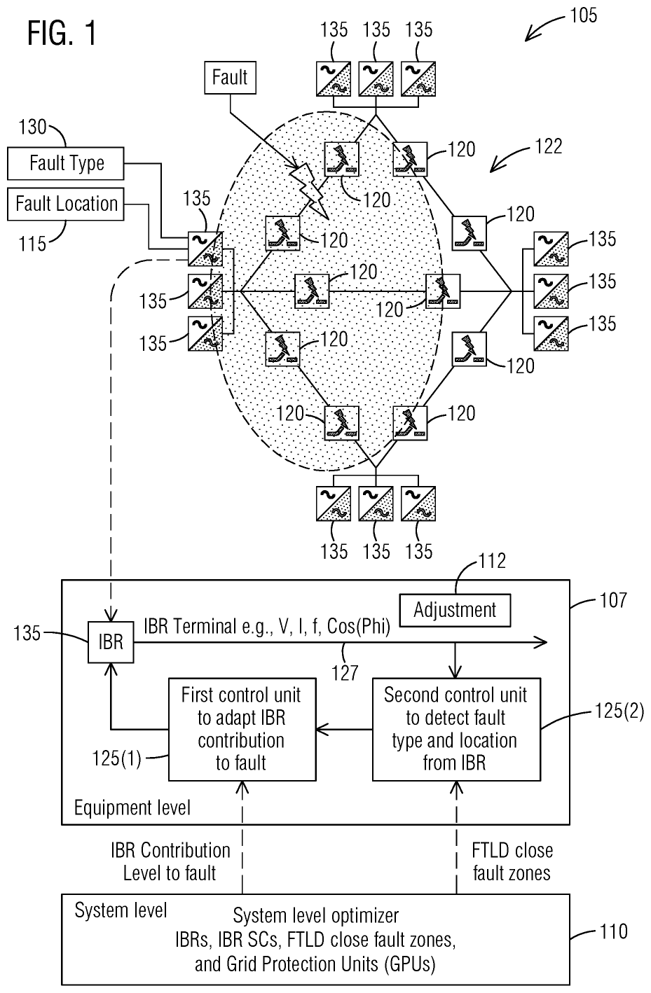

These and other embodiments of an optimized protection system according to the present disclosure are described below with reference to FIGS. 1-3 herein. Like reference numerals used in the drawings identify similar or identical elements throughout the several views. The drawings are not necessarily drawn to scale.

Consistent with one embodiment of the present invention, FIG. 1 represents a block diagram of an optimized protection system 105 in which an equipment-level protection scheme 107 is integrated with a system-level optimizer 110 to provide an IBR adaptive or optimized fault-level adjustment 112 based on one or more fault locations 115 and fault types 130 in accordance with an exemplary embodiment of the present invention. The optimized protection system 105 includes distributed energy resources (DERs) with customers as transmission and distribution owner/independent system operators. The optimized protection system 105 comprises one or more grid protection units (GPUs) 120 that represent all other existing protection devices in a power grid 122. The optimized protection system 105 further comprises the equipment-level protection scheme 107 which contains first and second control units 125(1-2). The first control unit 125(1) controls an inverter-based resource (IBR) output 127 and the second control unit 125(2) identifies one or more fault types 130 and locations 115 in the power grid 122. The optimized protection system 105 further comprises the system-level optimizer 110 for co-optimization of an IBR 135, the first control unit 125(1), the second control unit 125(2) together with the one or more grid protection units (GPUs) 120 such that they together optimize the global protection performance regarding dependability, security, and operation speed for any kind of grid faults. The equipment-level protection scheme 107 and the system-level optimizer 110 adaptively provide the IBR adaptive or optimized fault-level adjustment 112 based on the fault location 115 of the one or more fault locations.

In one embodiment, the first control unit 125(1) is an inverter-based resource supervisory controller (IBR SC) and the second control unit 125(2) is a fault type and location detector (FTLD) unit integrated with the IBR SC at each inverter-based resource (IBR) location of one or more IBR locations. The FTLD unit has also close-fault-zone characteristics to define which close faults should be considered for an IBR output adjustment. For such close faults, each IBR produces adaptively enough reactive and/or active fault currents so that existing grid protection units (GPUs) 120 detect and isolate the faulty part(s). The optimized protection system 105 defines an IBR output/contribution e.g., voltage, current, frequency, and power factor (Cos Phi) during a fault incident by using one or more fault types and locations identified by the FTLD unit such that the IBR output/contribution is controlled in a closed loop feedback at at least two levels (e.g., a Level 1 (Equipment Level) and a Level 2 (System Level)).

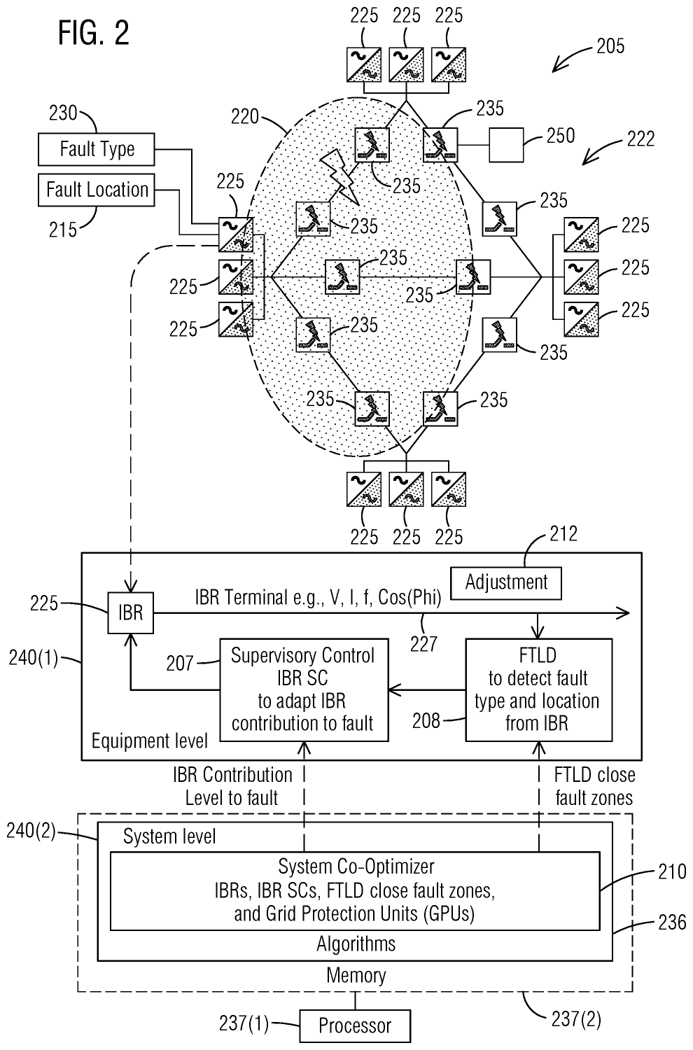

Referring to FIG. 2, it illustrates a block diagram of an optimized protection system 205 in which an inverter-based resource supervisory controller (IBR SC) 207 is integrated with a fault type and location detector (FTLD) unit 208 and a system co-optimizer 210 to provide an IBR adaptive fault-level adjustment 212 based on one or more fault locations 215 and fault types 230 in accordance with an exemplary embodiment of the present invention. The optimized protection system 205 includes distributed energy resources (DERs) with customers as transmission and distribution owner/independent system operators. The optimized protection system 205 comprises the inverter-based resource supervisory controller (IBR SC) 207 that controls an inverter-based resource (IBR) output/contribution 227.

The optimized protection system 205 further comprises the fault type and location detector (FTLD) unit 208 integrated with the IBR SC 207 at each inverter-based resource (IBR) location of one or more IBR 225 locations. The FTLD unit 208 identifies one or more fault types 230 and fault locations 215 in a power grid 222. The FTLD unit 208 has also close-fault-zone 220 characteristics to define which close faults should be considered for the IBR adaptive fault-level adjustment 212. For such close faults, each IBR 225 produces adaptively enough reactive and/or active fault currents so that existing grid protection units (GPUs) detect and isolate the faulty part(s).

The optimized protection system 205 further comprises the system co-optimizer 210 for co-optimization of the IBR 225, the IBR SC 207, FTLD close fault zones 220 and grid protection units (GPUs) 235 such that they together optimized the optimized protection system 205 performance regarding dependability, security, and operation speed for any kind of grid faults. In one embodiment, the system 205 operates a program such that the system 205 comprises a processor 237(1) and a memory 237(2) for storing algorithms 236 executed by the processor 237(1). The algorithms 236 comprise the system co-optimizer 210 that is located in a cloud or in the power grid 222.

The optimized protection system 205 defines an IBR output/contribution e.g., voltage, current, frequency, and power factor (Cos Phi) during a fault incident by using the fault type 230 and the fault location 215 identified by the FTLD unit 208 such that the IBR output/contribution 227 is controlled in a closed loop feedback at at least two levels.

Consistent with one embodiment, at least two levels include a Level 1 (Equipment Level) 240(1). The IBR SC 207 with fixed controller parameters controls the IBR output/contribution 227 and the IBR SC 207 receives feedback from the FTLD unit 208 that identifies the fault type 230 and the fault location 215 in the power grid 222. The parameters for the IBR SC 207 and the FTLD unit 208 can be planned and designed for each IBR site and best practices/guidelines to adjust such parameters can also be defined. Protection coordination, simulation, and validation tools which are working based on stationary root mean square (RMS) phasors can be applied to adjust IBR SC and FTLD parameters.

At least two levels further include a Level 2 (System Level) 240(2). The IBR 225, the IBR SC 207, the FTLD unit 208, as well as the GPUs 235 are co-optimized together according to the following approach. Each optimization element (the IBR 225, the IBR SC 207, the FTLD unit 208, and the GPUs 235) will have an optimization model with tunable control and protection (C&P) parameters and each optimization element may have fixed or flexible curves (or characteristic) to be tuned during co-optimization. Each optimization element can have constraint(s) on its parameters and/or curves. A target function of co-optimization may be defined so that all power system faults be cleared in a dependable, secure manner and with a fast speed. Mixed-integer nonlinear programming (MINLP) optimization methods are be applied initially.

To validate optimized results the optimized protection system 205 should be capable of co-simulating (protection and (transient stability (RMS) or electromagnetic transient (EMT) behavior)) with a detailed simulation model for optimized elements. For co-optimization among the IBR 225, the IBR SC 207, and FTLD elements modelling of a power system including parameters k1 of generators, e.g., controller gains and limits is done. The inverter-based resources (IBRs) 225 are generators which include IBRs or synchronous generator-based generators like gas turbines or steam turbines, e.g., in coal or nuclear power plants. For co-optimization among the IBR 225, the IBR SC 207, and FTLD elements modelling of the power system including parameters k2 of grid protection units (GPUs) that define when protection relays open their circuit breaker is done. For co-optimization among the IBR 225, the IBR SC 207, and FTLD elements modelling of IBR supervisory controller (IBR SC) units 207 including parameters k3, e.g., controller gains and limits is done. For co-optimization among the IBR 225, the IBR SC 207, and FTLD elements modelling of fault type and location detector (FTLD) units 208 at IBR 225 locations including parameters k4, e.g., fault location impedance is done. For co-optimization among the IBR 225, the IBR SC 207, and FTLD elements formulating and solving an optimization problem that optimizes the parameters k1, k2, k3, and k4 to minimize a fault clearing time while guaranteeing dependability and security (sometimes called also as sensitivity and selectivity) of a protection scheme. Here dependability means that the protection devices do operate wherever is needed to clear a fault and security means that the protection devices do not operate wherever not needed (e.g. only those devices closest to a fault trigger to operate first).

Software tools make system level co-optimization possible by the system co-optimizer 210. Also, software tools validate optimized results. Such software tools are capable of to co-simulate protection, transient stability (RMS), and electromagnetic transient (EMT) behavior with a detailed simulation model for optimized elements.

FTLD close-fault-zone 220 detection characteristic(s) at each IBR location can be designed to have overlap with adjacent FTLD zones. This ensures that all grid fault locations are detectable and only required IBR near faulty asset needed to adjust their fault contribution so that the fault be cleared successfully by existing grid protection units (GPUs) without a need to additional communication infrastructure. This avoids additional investment in grid and ensure reliable protection operations in IBR dominated grids.

Additionally, the co-optimization of the IBR 225, the IBR SC 207, and the FTLD unit 208 together optimized the protection system 205 performance regarding dependability, security, and operation speed for any kind of grid faults. The IBR 225, the IBR SC 207, and the FTLD unit 208 can also be provided from different vendors providing\using standard interfaces which is attractive for controller\automation market.

Technical features to detect DERs/IBRs near to a grid fault and adjust their contribution to a level that existing grid protection units (GPUs) can clear fault successfully, are as follows:
FTLD close-fault-zone detector at a DER/IBR location.
IBR supervisory control (IBR SC) to adjust the IBR contribution regarding e.g., voltage, current, frequency, and power factor (Cos Phi).
Design FTLD and IBR SC parameters via protection coordination, simulation, and validation tools in the market which are working based on stationary RMS phasors.
Optimize designed parameters by optionally globally co-optimization among IBR, IBR SC, FTLD, and GPU optimization models.

In accordance with one illustrative embodiment of the present invention, the protection system 205 for a power system such as the power grid 222 consisting of power lines, transformers, generation units, and loads is provided. The protection system 205 comprises one or more grid-protection units (GPUs) 235 associated with the power lines, the transformers, the generation units, or the loads of the power system. A grid-protection unit (GPU) 235 includes at least one grid-protection unit protection function (GPU PF) 250 that detects fault signals like currents or voltages and disconnects a power line, a transformer, a generation unit, or a load based on the GPU PF 250. The protection system 205 further comprises a plurality of inverter-based resources (IBRs) 225 as the generation units. An IBR 225 includes the inverter-based resource supervisory controller (IBR SC) 207 that controls an inverter-based resource (IBR) output 127/227. The protection system 205 further comprises the processor 237(1) and the memory 237(2) for storing algorithms 236 executed by the processor 237(1). The algorithms 236 comprise a protection system co-optimizer 210 for co-optimization of the IBR SC 207 and the GPU PF 250 such that they together optimize the protection system 205 performance regarding dependability, security, and operation speed for any kind of grid faults.

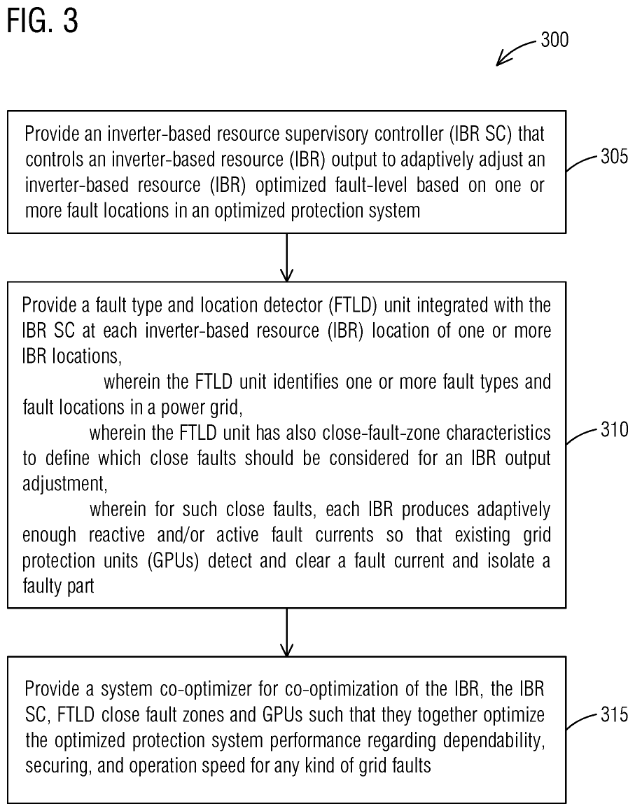

Turning now to FIG. 3, it illustrates a schematic view of a flow chart of a method 300 of adaptively adjusting an inverter-based resource (IBR) optimized fault-level based on one or more fault locations in accordance with an exemplary embodiment of the present invention. Reference is made to the elements and features described in FIGS. 1-2. It should be appreciated that some steps are not required to be performed in any particular order, and that some steps are optional.

The method comprises a step 305 for providing the inverter-based resource supervisory controller (IBR SC) 207 that controls the inverter-based resource (IBR) output/contribution 227. The method further comprises a step 310 for providing the fault type and location detector (FTLD) unit 208 integrated with the IBR SC 207 at each inverter-based resource (IBR) 225 location of one or more IBR locations. The FTLD unit 208 identifies the fault types 230 and fault locations 215 in the power grid 222. The FTLD unit 208 has also close-fault-zone 220 characteristics to define which close faults should be considered for the IBR output adjustment 212. For such close faults, each IBR 225 produces adaptively enough reactive and/or active fault currents so that existing grid protections detect and isolate the faulty part(s). The method further comprises a step 315 for providing the system co-optimizer 210 for co-optimization of the IBR 225, the IBR SC 207, FTLD close fault zones 220 and (GPUs) 235 such that they together optimized the optimized protection system 205 performance regarding dependability, security, and operation speed for any kind of grid faults.

While the inverter-based resources (IBRs) are described here a range of one or more other types of resources or other forms of resources are also contemplated by the present invention. For example, other types of resources may be implemented based on one or more features presented above without deviating from the spirit of the present invention.

The techniques described herein can be particularly useful for an objective function-based optimization. While particular embodiments are described in terms of the objective function-based optimization, the techniques described herein are not limited to an objective function-based optimization but can also be used with other optimization schemes.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A protection system for a power system consisting of power lines, transformers, generation units, and loads, the protection system comprising:
one or more grid-protection units (GPUs) associated with the power lines, the transformers, the generation units, or the loads of the power system, wherein a grid-protection unit (GPU) including:
at least one grid-protection unit protection function (GPU PF) that detects fault signals like currents or voltages and disconnects a power line, a transformer, a generation unit, or a load based on the GPU PF;
a plurality of inverter-based resources (IBRs) as the generation units, wherein at least one IBR including:
an inverter-based resource supervisory controller (IBR SC) that controls an inverter-based resource (IBR) output;
a processor; and
a memory for storing algorithms executed by the processor, wherein the algorithms comprise a protection system co-optimizer for co-optimization of the IBR SC and the GPU PF such that they together optimize the protection system performance regarding dependability, security, and operation speed for any kind of grid faults.

2. The protection system of claim 1, wherein the at least one IBR further comprising:
a fault type and location detector (FTLD) unit integrated with the IBR SC at each inverter-based resource (IBR) location of one or more IBR locations, wherein the FTLD unit identifies one or more fault types and one or more fault locations in a power grid,
wherein the FTLD unit has also close-fault-zone characteristics to define which close faults should be considered for an IBR output adjustment,
wherein for such close faults, each IBR produces adaptively enough reactive and/or active fault currents so that existing grid protection units detect and isolate one or more faulty parts, and
wherein the system defines an IBR output/contribution e.g., voltage, current, frequency, and power factor (Cos Phi) during a fault incident by using the one or more fault types and the one or more fault locations identified by the FTLD unit such that the IBR output/contribution is controlled in a closed loop feedback at at least two levels.

3. The protection system of claim 2, wherein the at least two levels include a Level 1 (Equipment Level):
wherein the IBR SC with fixed controller parameters controls the IBR output/contribution and the IBR SC receives feedback from the FTLD unit that identifies the fault type and the fault locations in a power grid,
wherein parameters for the IBR SC and the FTLD unit can be planned and designed for each IBR site and best practices/guidelines to adjust such parameters can also be defined, and
wherein protection coordination, simulation, and validation tools which are working based on stationary RMS phasors can be applied to adjust IBR SC and FTLD parameters.

4. The protection system of claim 3, wherein the at least two levels include a Level 2 (System Level):
wherein the IBR, the IBR SC, the FTLD unit, as well as the GPUs are co-optimized together according to the following approach:
wherein each optimization element (the IBR, the IBR SC, the FTLD unit, and the GPU PF) will have an optimization model with tunable control and protection (C&P) parameters and each optimization element may have fixed or flexible curves (or characteristic) to be tuned during co-optimization,
wherein each optimization element can have constraint(s) on its parameters and/or curves,
wherein a target function of co-optimization is defined so that all power system faults be cleared in a dependable, secure manner and with a fast speed, and
wherein mixed-integer nonlinear programming (MINLP) optimization methods are be applied initially.

5. The protection system of claim 4, wherein to validate optimized results the system should be capable of co-simulating (protection and (transient stability (RMS) or electromagnetic transient (EMT) behavior)) with a detailed simulation model for optimized elements.

6. The protection system of claim 5, wherein for co-optimization among the IBR, the IBR SC, FTLD and GPU PF elements:
modelling of a power system including parameters k1 of generators, e.g., controller gains and limits, wherein the inverter-based resources (IBRs) are generators which include IBRs or synchronous generator-based generators like gas turbines or steam turbines, e.g., in coal or nuclear power plants.

7. The protection system of claim 6, wherein for co-optimization among the IBR, the IBR SC, FTLD and GPU PF elements:
modelling of the power system including parameters k2 of the GPU PF that define when protection relays open their circuit breaker, e.g., based on over-currents or under-voltages.

8. The protection system of claim 7, wherein for co-optimization among the IBR, the IBR SC, FTLD and GPU PF elements:
modelling of IBR supervisory controller (IBR SC) units including parameters k3, e.g., controller gains and limits.

9. The protection system of claim 8, wherein for co-optimization among the IBR, the IBR SC, FTLD and GPU PF elements:
modelling of fault type and location detector (FTLD) units at IBR locations including parameters k4, e.g., fault location impedance.

10. The protection system of claim 9, wherein for co-optimization among the IBR, the IBR SC, FTLD and GPU PF elements:
formulating and solving an optimization problem that optimizes the parameters k1, k2, k3, and k4 to minimize a fault clearing time while guaranteeing dependability and security (sometimes called also as sensitivity and selectivity) of a protection scheme,
wherein dependability means that the protection devices do operate wherever is needed, e.g., to clear a fault, and
wherein security means that the protection devices do not operate wherever not needed, e.g., only those devices closest to a fault trigger to operate first.

11. A method of adaptively adjusting an inverter-based resource (IBR) optimized fault-level based on one or more fault locations in an optimized protection system, the method comprising:
providing an inverter-based resource supervisory controller (IBR SC) that controls an inverter-based resource (IBR) output;
providing a fault type and location detector (FTLD) unit integrated with the IBR SC at each inverter-based resource (IBR) location of one or more IBR locations, wherein the FTLD unit identifies one or more fault types and one or more fault locations in a power grid,
wherein the FTLD unit has also close-fault-zone characteristics to define which close faults should be considered for an IBR output adjustment,
wherein for such close faults, each IBR produces adaptively enough reactive and/or active fault currents so that existing grid protection units (GPUs) detect and isolate the one or more faulty parts; and
providing a system co-optimizer for co-optimization of the IBR, the IBR SC, FTLD close fault zones and grid-protection unit protection functions (GPU PFs) such that they together optimized the optimized protection system performance regarding dependability, security, and operation speed for any kind of grid faults.

12. The method of claim 11, wherein the system defines an IBR output/contribution e.g., voltage, current, frequency, and power factor (Cos Phi) during a fault incident by using the one or more fault types and the one or more fault locations identified by the FTLD unit such that the IBR output/contribution is controlled in a closed loop feedback at at least two levels.

13. The method of claim 12, wherein the at least two levels include a Level 1 (Equipment Level):
wherein the IBR SC with fixed controller parameters controls the IBR output/contribution and the IBR SC receives feedback from the FTLD unit that identifies the fault type and the fault locations in a power grid,
wherein parameters for the IBR SC and the FTLD unit can be planned and designed for each IBR site and best practices/guidelines to adjust such parameters can also be defined, and
wherein protection coordination, simulation, and validation tools which are working based on stationary RMS phasors can be applied to adjust IBR SC and FTLD parameters.

14. The method of claim 13, wherein the at least two levels include a Level 2 (System Level):
wherein the IBR, the IBR SC, the FTLD unit, as well as the GPUs are co-optimized together according to the following approach:
wherein each optimization element (the IBR, the IBR SC, the FTLD unit, and the GPUs) will have an optimization model with tunable control and protection (C&P) parameters and each optimization element may have fixed or flexible curves (or characteristic) to be tuned during co-optimization,
wherein each optimization element can have constraint(s) on its parameters and/or curves,
wherein a target function of co-optimization is defined so that all power system faults be cleared in a dependable, secure manner and with a fast speed, and
wherein mixed-integer nonlinear programming (MINLP) optimization methods are be applied initially.

15. The method of claim 14, wherein to validate optimized results the system should be capable of co-simulating (protection and (transient stability (RMS) or electromagnetic transient (EMT) behavior)) with a detailed simulation model for optimized elements.

16. The method of claim 15, wherein for co-optimization among the IBR, the IBR SC, FTLD and GPU PF elements:
modelling of a power system including parameters k1 of generators, e.g., controller gains and limits, wherein the inverter-based resources (IBRs) are generators which include IBRs or synchronous generator-based generators like gas turbines or steam turbines, e.g., in coal or nuclear power plants;
modelling of the power system including parameters k2 of the GPU PFs that define when protection relays open their circuit breaker;
modelling of IBR supervisory controller (IBR SC) units including parameters k3, e.g., controller gains and limits;
modelling of fault type and location detector (FTLD) units at IBR locations including parameters k4, e.g., fault location impedance; and
formulating and solving an optimization problem that optimizes the parameters k1, k2, k3, and k4 to minimize a fault clearing time while guaranteeing dependability and security (sometimes called also as sensitivity and selectivity) of a protection scheme,
wherein dependability means that the protection devices do operate wherever is needed, e.g., to clear a fault, and
wherein security means that the protection devices do not operate wherever not needed, e.g., only those devices closest to a fault trigger to operate first.

17. A protection system for a power system consisting of power lines, transformers, generation units, and loads, the protection system comprising:
one or more grid protection units (GPUs) that represent all other existing protection devices in a power grid; and
an equipment-level protection scheme which contains first and second control units, wherein the first control unit controls an inverter-based resource (IBR) output and the second control unit identifies one or more fault types and one or more fault locations in the power grid; and
a system-level optimizer for co-optimization of an IBR, the first control unit, the second control unit together with the one or more grid protection units (GPUs) such that they together optimize the global protection performance regarding dependability, security, and operation speed for any kind of grid faults, wherein the equipment-level protection scheme and the system-level optimizer to adaptively provide an IBR optimized fault-level adjustment based on the fault location of the one or more fault locations.

18. The optimized protection system of claim 17, wherein the first control unit is an inverter-based resource supervisory controller (IBR SC) and the second control unit is a fault type and location detector (FTLD) unit integrated with the IBR SC at each inverter-based resource (IBR) location of one or more IBR locations,
wherein the FTLD unit has also close-fault-zone characteristics to define which close faults should be considered for an IBR output adjustment,
wherein for such close faults, each IBR produces adaptively enough reactive and/or active fault currents so that existing grid protection units (GPUs) detect and isolate the one or more faulty parts, and
wherein the system defines an IBR output/contribution e.g., voltage, current, frequency, and power factor (Cos Phi) during a fault incident by using the one or more fault types and the one or more fault locations identified by the FTLD unit such that the IBR output/contribution is controlled in a closed loop feedback at at least two levels.

19. The optimized protection system of claim 18, wherein the at least two levels include a Level 1 (Equipment Level):
wherein the IBR SC with fixed controller parameters controls the IBR output/contribution and the IBR SC receives feedback from the FTLD unit that identifies the fault types and the fault locations in a power grid,
wherein parameters for the IBR SC and the FTLD unit can be planned and designed for each IBR site and best practices/guidelines to adjust such parameters can also be defined, and
wherein protection coordination, simulation, and validation tools which are working based on stationary RMS phasors can be applied to adjust IBR SC and FTLD parameters.

20. The optimized protection system of claim 19, wherein the at least two levels include a Level 2 (System Level):
wherein the IBR, the IBR SC, the FTLD unit, as well as grid-protection unit protection functions (GPU PFs) are co-optimized together according to the following approach:
wherein each optimization element (the IBR, the IBR SC, the FTLD unit, and the GPU PF) will have an optimization model with tunable control and protection (C&P) parameters and each optimization element may have fixed or flexible curves (or characteristic) to be tuned during co-optimization,
wherein each optimization element can have constraint(s) on its parameters and/or curves,
wherein a target function of co-optimization is defined so that all power system faults be cleared in a dependable, secure manner and with a fast speed, and
wherein mixed-integer nonlinear programming (MINLP) optimization methods are be applied initially.
